(19) United States
(12) Patent Application Publication
(10) Pub. No.: US 2010/0149051 A1
(43) Pub. Date: Jun. 17, 2010

(54) ANTENNA DEVICE FOR PORTABLE WIRELESS TERMINAL

(75) Inventors: Young-Jun CHO, Anyang-si (KR); Byung-Man LIM, Seoul (KR); Yong-Jin KIM, Seoul (KR); Jae-Ho LEE, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/638,351

(22) Filed: Dec. 15, 2009

(30) Foreign Application Priority Data
Dec. 15, 2008 (KR) 10-2008-0127403

(51) Int. Cl. H01Q 1/24; H01Q 1/50

(52) U.S. Cl. 343/702; 343/906

(57) ABSTRACT

An antenna device of a portable wireless terminal is provided. The device includes a mainboard, a slot cover, and an electrical connection unit. The mainboard includes a feed part connected to a Radio Frequency (RF) connector. The slot cover opens/closes a slot formed in a case frame forming an appearance of the portable wireless terminal in order to connect to a connector of an external apparatus, and includes an antenna radiator for transmitting/receiving a signal in a relevant frequency band. The electrical connection unit electrically connects the slot cover with the feed part. Therefore, the antenna device may improve a radiation performance by securing a space of the antenna radiator without increasing the volume of the terminal.

### PRIORITY

This application claims the benefit under 35 U.S.C. §119(a) of a Korean patent application filed in the Korean Intellectual Property Office on Dec. 15, 2008 and assigned Serial No. 10-2008-0127403, the entire disclosure of which is hereby incorporated by reference.

### BACKGROUND OF THE INVENTION

1. Field of the Invention

The present invention relates to an antenna device of a portable wireless terminal. More particularly, the present invention relates to an antenna device having improved radiation efficiency without increasing the volume of the portable wireless terminal.

2. Description of the Related Art

As the electronic communication industry develops, portable wireless terminals are becoming lighter, slimmer, smaller, and more multi-functional. For example, a portable wiress terminal is now typically equipped with a speaker unit, capable of implementing various chords and melodies, and a color display unit, capable of displaying millions of pixels. Also, in addition to a call function, the portable wireless terminal now typically provides a music listening function through a Motion Picture Expert Group Audio Layer-3 (MP3) Player (MP3P). Furthermore, through the color display unit, the portable wireless terminal provides functions for receiving not only various game contents but also radio and Digital Multimedia Broadcasting (DMB) contents.

In general, a portable wireless terminal primarily uses a built-in antenna which allows the terminal to be made light and slim. However, if it is desired to provide the portable wireless terminal with the capability for greater radio wave transmission/reception, the built-in antenna may be designed to be large so as to have high directivity. In such a case, the spacing distances between other parts within the terminal decrease in order to maintain the lightness and smallness of the portable wireless terminal. Therefore, it is difficult to secure the space for the larger antenna and improve the transmission/reception performance of the terminal. Furthermore, the portable wireless terminal typically uses a metallic cover, a metallic case frame, and metallic accessories, etc. for durability and appearance. Such use of the metallic units further deteriorates the performance of the built-in antenna.

Accordingly, there is a need for an antenna device for a portable wireless terminal to improve the radiation efficiency.

### SUMMARY OF THE INVENTION

An aspect of the present invention is to address at least the above-mentioned problems and/or disadvantages and to provide at least the advantages described below. Accordingly, an aspect of the present invention is to provide an antenna device for a portable wireless terminal to improve radiation performance by securing an antenna space without increasing the volume of the portable wireless terminal.

Another aspect of the present invention is to provide an antenna device for a portable wireless terminal to improve radiation performance by incorporating an antenna radiator for transmitting/receiving signals into a slot cover for a slot provided to a case frame, for connecting an external apparatus to the portable wireless terminal.

In accordance with an aspect of the present invention, an antenna device for a portable wireless terminal is provied. The device includes a mainboard comprising a feed part connected to a Radio Frequency (RF) connector, a slot cover for opening/closing a slot formed in a case frame defining an outer surface of the portable wireless terminal in order to connect to a connector of an external apparatus, and comprising an antenna radiator for transmitting/receiving a signal, and an electrical connection unit for electrically connecting the slot cover with the feed part.

In accordance with another aspect of the present invention, a portable wireless terminal is provided. The terminal includes a mainboard comprising a feed part connected to a Radio Frequency (RF) connector, a slot cover for opening/closing a slot formed in a case frame defining an outer surface of the portable wireless terminal in order to connect to a connector of an external apparatus, and comprising an antenna radiator for transmitting/receiving a signal, and an electrical connection unit for electrically connecting the slot cover with the feed part.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view illustrating a portable wireless terminal according to an exemplary embodiment of the present invention;

FIGS. 2A and 2B are exploded perspective views illustrating parts of a sub antenna device according to an exemplary embodiment of the present invention;

FIG. 3 is a perspective view illustrating a cross-section of a slot cover according to an exemplary embodiment of the present invention;

FIG. 4 is a coupled perspective view of a sub antenna device according to an exemplary embodiment of the present invention;

FIG. 5 is a view illustrating a state after a slot cover in FIG. 4 is transferred according to an exemplary embodiment of the present invention;

FIG. 6 is a view illustrating a state in which the slot cover is rotated after being transferred in FIG. 5 according to an exemplary embodiment of the present invention;

FIG. 7 is a view illustrating a sub antenna device according to an exemplary embodiment of the present invention;

FIG. 8 is a view illustrating a sub antenna device according to an exemplary embodiment of the present invention; and

FIG. 9 is a view illustrating Voltage Standing Wave Ratio (VSWR) values and radiation efficiency in a Bluetooth frequency band when a sub antenna device according to an exemplary embodiment of the present invention is used.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a built-in antenna device of a portable wireless terminal. More particularly, the present invention provides an antenna device that is installed in a case frame to perform wireless communication and improve the radiation efficiency of a portable wireless terminal.

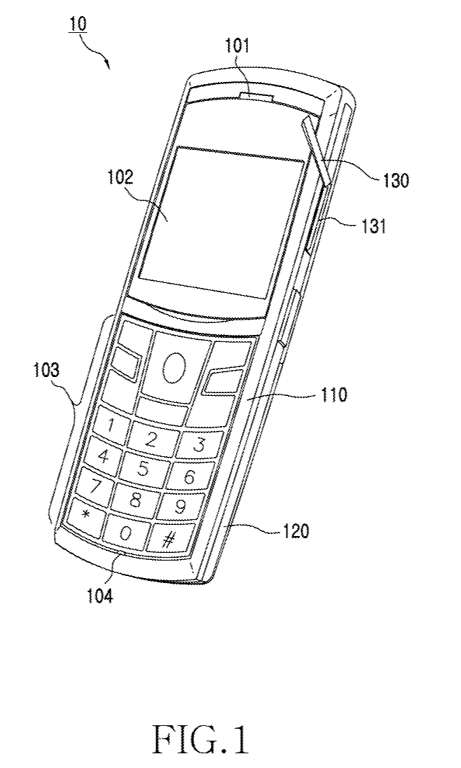

In addition, though a bar type portable wireless terminal is described according to an exemplary embodiment of the present invention as illustrated in FIG. 1, the present invention is not limited thereto but may be readily applied to a folder type portable wireless terminal, a slide type portable wireless terminal, and the like.

FIG. 1 is a perspective view illustrating a portable wireless terminal according to an exemplary embodiment of the present invention.

Referring to FIG. 1, the portable wireless terminal 10 includes a case frame defining an outer surface thereof. The case frame includes a top case frame 110 and a bottom case frame 120 coupled to the top case frame 110 to provide an inner space. The top/bottom case frames 110 and 120 are joined together following the placement of elements in the inner space.

The portable wireless terminal 10 includes a speakerphone 101 for outputting a voice signal, and a display 102, disposed near the speakerphone, for outputting a video signal. The case frame further includes a keypad assembly 103, serving as a data input unit, and a microphone 104 disposed near the keypad assembly 103 to input an audio signal. The display 102 may be a Liquid Crystal Display (LCD) with millions of pixels. In an exemplary implementation, the LCD is provided with a touchscreen so that the display 102 may serve as a supplemental data input unit or as a data input unit instead of the keypad assembly 103.

In addition, the portable wireless terminal 10 includes at least one built-in antenna device (not shown and referred to as a ‘main antenna device’ hereinafter) installed in the inner space of the case frame to perform wireless communication. The main antenna device may include an antenna radiator, having a radiation pattern, to radiate an electromagnetic wave. The antenna radiator is mounted on a carrier. The antenna radiator is connected to a feed part connected to a Radio Frequency (RF) connector of a mainboard (not shown) to radiate an electrical signal (e.g., a current) received from the feed part. In addition, the antenna radiator may be connected to a ground part connected to the RF connector of the mainboard. Moreover, the main antenna device may be a chip type antenna device surface-mounted so that it is connected to the RF connector of the mainboard to transmit/receive a signal. For example, the chip type built-in antenna device may transmit/receive a signal in a frequency band of short-range wireless communication, for example, a Bluetooth frequency band.

The portable wireless terminal 10 provides an external slot 131 formed in the case frame as a path for connecting a connector of an external apparatus such as an ear-jack, a memory, etc. to a relevant port formed in the mainboard (not shown). The external slot 131 may be formed in the upper case frame 110 or the lower case frame 120. Alternatively, as described below, the external slot 131 may be formed by combination of the upper case frame 110 and the lower case frame 120.

In addition, for protection of the external slot 131 and elegant appearance, the portable wireless terminal 10 includes a slot cover 130 for selectively opening/closing the external slot 131 depending on whether the external slot 131 is used. For example, the slot cover 130 may be drawn away from the external slot 131 with external force and then rotated about its one end as an axis so that it does not hinder entry of a connector of an external apparatus.

According to an exemplary embodiment of the present invention, the slot cover 130 includes the antenna radiator for transmitting/receiving a signal. In addition, the antenna radiator may be electrically connected to the feed part that electrically communicates with the RF connector of the mainboard (not shown) to radiate radio waves as an antenna.

Though even when inserted into the external slot 131, the slot cover 130 transmits/receives a signal, the slot cover 130 may have an excellent radiation performance when detached from the external slot 131 and rotated at an angle as illustrated in FIG. 1.

An antenna device (referred to as a ‘sub antenna device’ hereinafter) formed using the slot cover 130 as a radiator may independently transmit/receive a signal in a relevant frequency band. That is, the sub antenna device of the portable wireless terminal 10 may transmit/receive a signal in a frequency band different from that of the main antenna device. Moreover, the sub antenna device may transmit/receive a signal in a relevant frequency band on behalf of the main built-in antenna device.

Although not illustrated in FIG. 1, the portable wireless terminal includes a controller for performing an overall control. In an exemplary implementation, the controller compares a radio signal strength of the main antenna device with that of the sub antenna device, and controls to use an antenna device whose signal strength is stronger. For example, when inserted into the external slot 131, a signal received by the slot cover 130 may have a weaker signal strength than the signal strength of the main antenna device, but when drawn from the external slot 131 and then rotated, a signal received by the slot cover 130 may have a stronger signal strength than the signal strength of the main antenna device.

An exemplary structure of a sub antenna device that utilizes the slot cover 130 is described below.

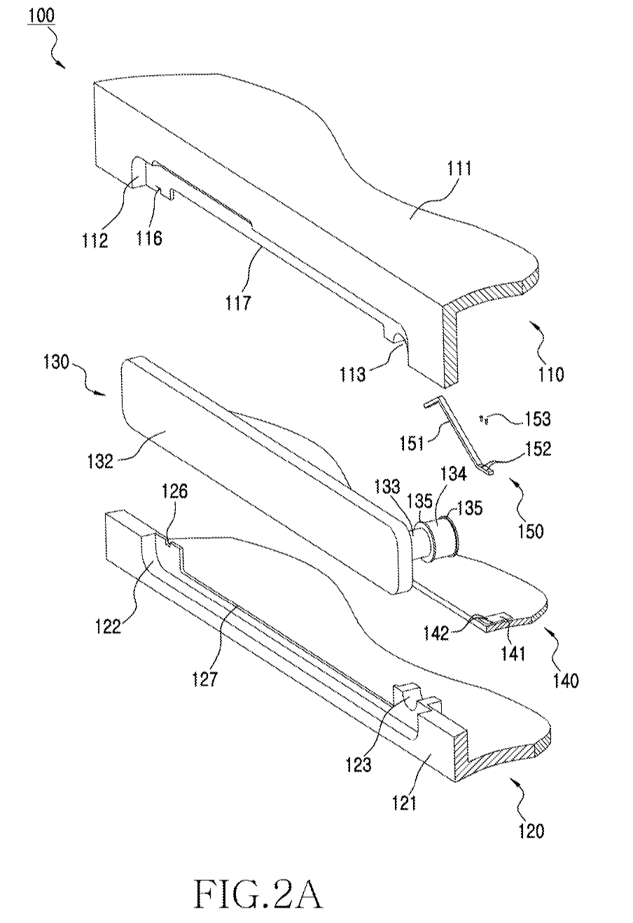

FIGS. 2A and 2B are exploded perspective views illustrating parts of a sub antenna device according to an exemplary embodiment of the present invention.

Referring to FIGS. 2A and 2B, the sub antenna device 100 includes the top case frame 110 and the bottom case frame 120 coupled to the top case frame 110 which define an outer surface of the terminal 10. In addition, the sub antenna device 100 includes a mainboard 140 of the terminal 10 mounted in an inner space formed by the top case frame 110 and the bottom case frame 120. Moreover, the sub antenna device 100 may be supported by the top case frame 110 and the bottom case frame 120, and transferred and rotated, and may include the slot cover 130 including an antenna radiator. In addition, the sub antenna device 100 includes an electrical connection unit 150 for electrically connecting the slot cover 130 to the mainboard 140.

The top case frame 110 and the bottom case frame 120 include, respectively, bodies 111 and 121 including seats 112 and 122 having height differences to seat the slot cover 130, and pass-through portions 117 and 127. The pass-through portions 117 and 127 allow an external connector of an external device such as an ear-jack, a memory, etc. to pass through the pass-through portions and to connect to a relevant port (not shown) of the mainboard 140. In addition, the bodies 111 and 121 of the top case frame 110 and the bottom case frame 120 include, respectively, rotation portions 113 and 123 having circular cross-sections which allow the slot cover 130 to transfer and rotate.

The slot cover 130 includes a radiation portion 132 including the radiator for transmitting/receiving a signal, and a cylindrical first shaft 133 which is electrically connected with the radiator of the radiation portion 132 transferable and rotatable from the rotation portions 113 and 123 formed by combination of the case frames 110 and 120. Moreover, the slot cover 130 includes a second shaft 134 connected to one end of the first shaft 133 for preventing the slot cover 130 from being detached to the outside from the above-combined rotation portions 113 and 123. Here, the second shaft 134 may have a circular cross-section of a diameter greater than those of the first shaft 133 and the combined rotation portions 113 and 123. As described below, the second shaft electrically contacts the electrical connection unit 150. Moreover, the second shaft 134 may further include a height difference portion 135 for increasing contact force of the electrical connection unit 150 while the slot cover 130 is being transferred.

The mainboard 140 includes a feed part 141 connected to an RF connector (not shown) in order to transfer an electrical signal (e.g., a current) to the slot cover 130 by the medium of the electrical connection unit 150.

The electrical connection unit 150 may be a bent metal plate having a first end electrically connected to the feed part 141 of the mainboard 140 and a second end electrically connected to a partial or entire portion of the second shaft 134. The metal plate may be fixed to the feed part 141 of the mainboard 140 using a screw coupling or soldering. For example, the electrical connection unit 150 includes a bent plate spring 151 having a first end fixedly and electrically connected to the feed part 141 of the mainboard 140, and a second end, supported by the first end, and electrically connected to the rotation plane of the second shaft 133 using downward elastic force. Moreover, the plate spring 151 may be fixed to the feed part 141 of the mainboard 140 using bolts 153 as illustrated in FIG. 2A. To accommodate the bolts 153, the plate spring 151 includes through holes 152 through which the bolts 153 pass, and the mainboard 140 includes screw recesses 142 formed in the feed part 141 to allow the bolts 153 to be coupled to the screw recesses 142. The plate spring 151 is not limited to the above structure. For example, the plate spring 151 may be soldered to the feed part 141 of the mainboard 140.

Moreover, the sub antenna device 100 may include a fixing unit for allowing the slot cover 130 to be transferred when at least a minimum external force or greater is applied after the slot cover 130 is seated on the combined seats 112 and 122. As illustrated in FIG. 2B, the fixing unit may include a hook-shaped protrusion 136 projected from the slot cover 130, and fixing recesses 116 and 126 formed in the upper and lower case frames 110 and 120, respectively, corresponding to the protrusion 136.

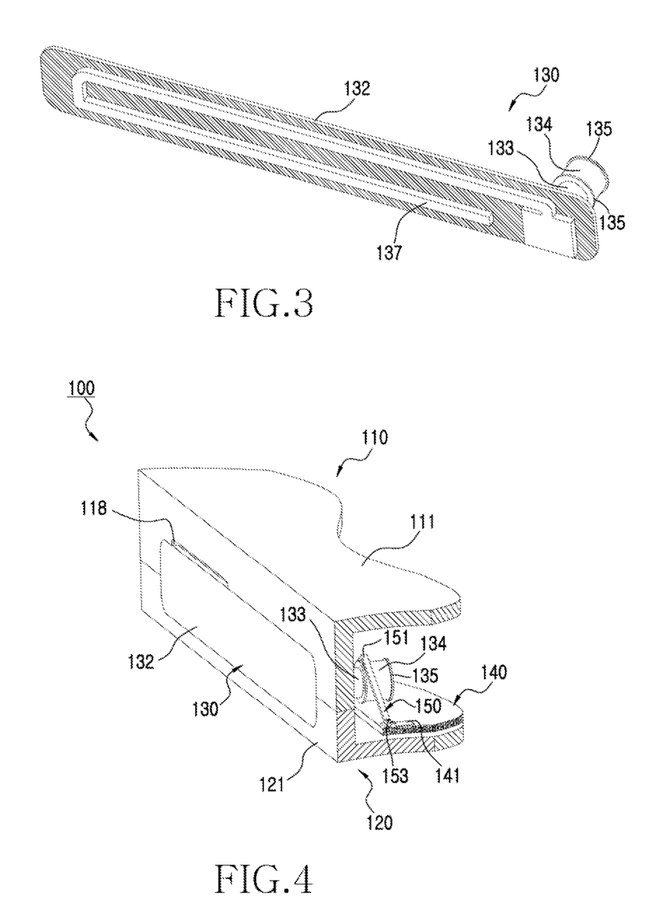

In addition, the sub antenna device 100 may further include a manipulation recess 118 as illustrated in FIG. 4 formed adjacent to the external surface of the slot cover 130 and formed in the top case frame 110 or the bottom case frame 120 in order to facilitate manipulation when a user transfers the slot cover 130. Alternatively, the manipulation recess 118 may be formed in the outer surface of the slot cover 130.

Therefore, the antenna radiator of the slot cover 130 is electrically connected to the feed part of the mainboard connected to the RF connector via the first shaft 133, the second shaft 134, and the plate spring 151 to transmit/receive signals.

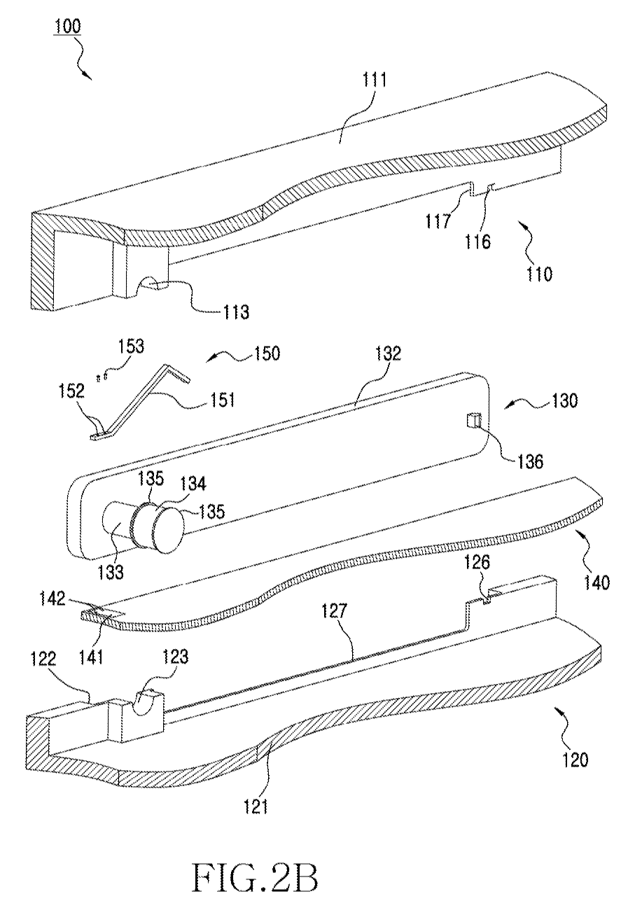

FIG. 3 is a perspective view illustrating a cross-section of a slot cover according to an exemplary embodiment of the present invention.

Referring to FIG. 3, the radiation portion 132 of the slot cover 130 includes an antenna radiator 137 electrically connected to the first shaft 133 and the second shaft 134, and having a pattern so that the antenna radiator 137 may transmit/receive signals. Here, the radiator 137 may be integrally formed and thus electrically connected with the first shaft 133 and the second shaft 134. In addition, the radiator 137 may further be molded with a soluble material such as rubber so as to define an outer surface of the radiation portion 132. The radiator 137 may be formed of a flexible material such as a flexible printed circuit having a pattern. Moreover, the radiation portion 132 is not limited thereto but may be formed of any metal or metallic material capable of receiving and radiating an RF signal.

The sub antenna device 100 may transmit/receive signals in one of a Bluetooth frequency band (2.4 GHz), a Wideband Code Division Multiple Access (WCDMA) frequency band (2.1 GHz), a Wireless Fidelity (Wi-Fi) frequency band, and a Satellite Digital Multimedia Broadcasting (SDMB) frequency band (2.6 GHz) by determining a pattern such as the length of the antenna radiator 137 included in the slot cover 130.

Moreover, as illustrated in the following drawings, the slot cover 130 may be formed using not only a monopole type antenna connected to the feed part 141 of the mainboard 140 but also a Planar Inverted F Antenna (PIFA) type antenna.

FIG. 4 is a coupled perspective view of a sub antenna device according to an exemplary embodiment of the present invention.

Referring to FIG. 4, since the slot cover 130 is seated on the seats 112 and 122 of the combined case frames 110 and 120, and the appearance before transfer does not substantially protrude past the surface of the combined case frames 110 and 120, an elegant appearance is provided. In the configuration as illustrated in FIG. 4, the protrusion 136 of the slot cover 130 is coupled to the combined fixing recesses 116 and 126. From this configuration, a user may easily pull the slot cover 130 away from the combined case frames 110 and 120 to rotate and transfer the slot cover 130 using the manipulation recess 118.

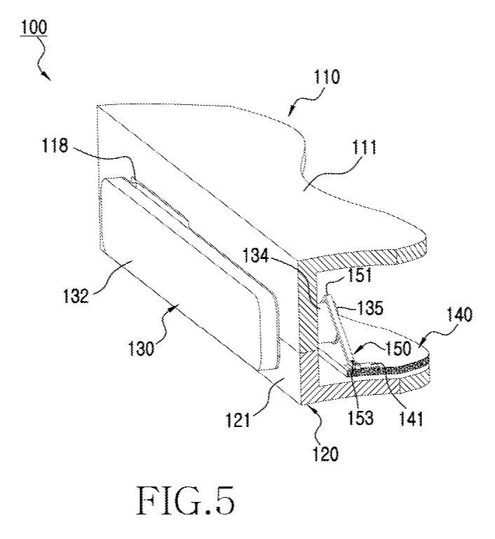

FIG. 5 is a view illustrating a state after a slot cover in FIG. 4 is transferred according to an exemplary embodiment of the present invention.

Referring to FIG. 5, a user may draw the slot cover 130 from the surface of the combined case frames 110 and 120 by applying an external force to the manipulation recess 118. That is, the manipulation recess 118 has a height difference from the combined case frames 110 and 120, thus allowing easier access to and manipulation of the slot cover 130. Here, the first shaft 133 and the second shaft 134 transfer along the rotation portions 113 and 123 of the combined case frames 110 and 120 due to the manipulation. After that, the second shaft 134 is hooked at the combined rotation portions 113 and 123, and the transfer stops. As illustrated, during the manipulation and rotation of slot cover 130, the plate spring 151 has maintained continuous contact with the second shaft 134 due to elastic restoring force even after the transfer.

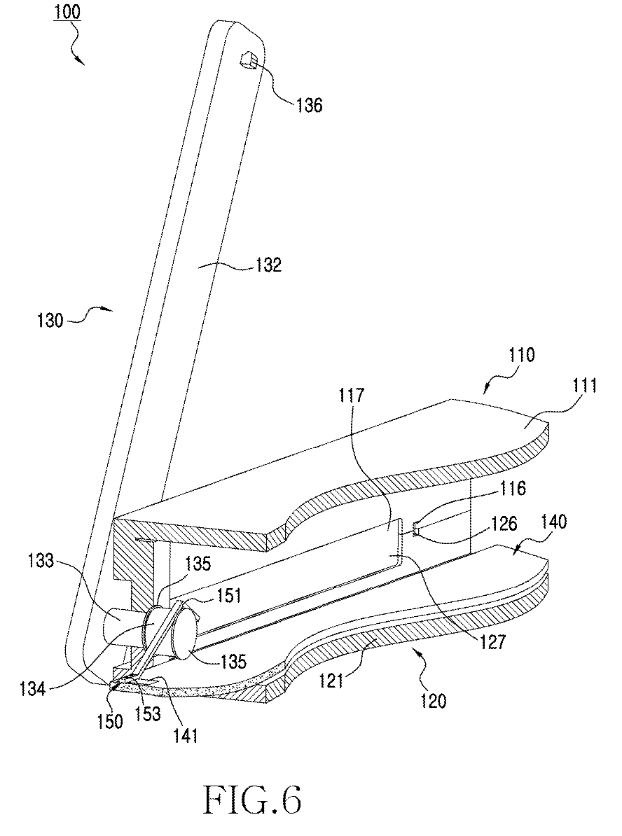

FIG. 6 is a view illustrating a state in which the slot cover is rotated after being transferred in FIG. 5 according to an exemplary embodiment of the present invention.

Referring to FIG. 6, the slot cover 130 that has been withdrawn and transferred from the surface of the combined case frames 110 and 120 is supported by the combined rotation portions 113 and 123 and may rotate about the first shaft 133 as an axis. In an exemplary embodiment, the slot cover 130, by means of the first shaft 133, may rotate 360°.

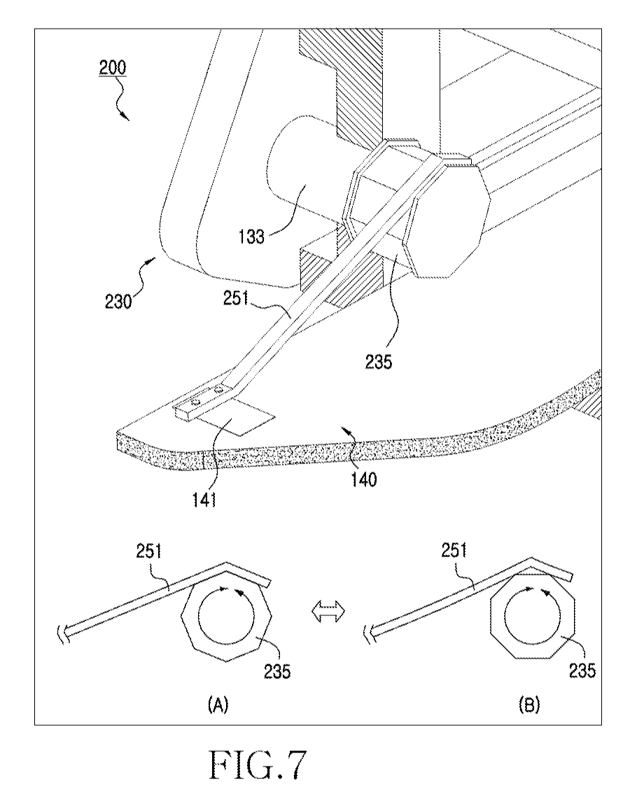

FIG. 7 is a view illustrating a sub antenna device according to an exemplary embodiment of the present invention. Description of the same elements as those of FIGS. 2 to 6 is omitted for clarity and convenience.

Referring to FIG. 7, and especially subframe (A) in FIG. 7, unlike the sub antenna device 100 described with reference to FIGS. 2 to 6, the illustrated sub antenna device 200, having slot cover 230, includes a second shaft 235 having a polygonal cross-section. Moreover, as illustrated in subframe (B) of FIG. 7, a bent portion of a plate spring 251 has a first end electrically connected to and supported by a feed part 141 of a mainboard 140 and has a second end matched with and supported by an apex of the second shaft 235. Therefore, when the second shaft 235 rotates, the plate spring 251 is elastically bent/transformed, and then the bent portion of the plate spring 251 has a tendency of being engaged with the apex of the second shaft 235, which may give sense of gradual rotation to a user.

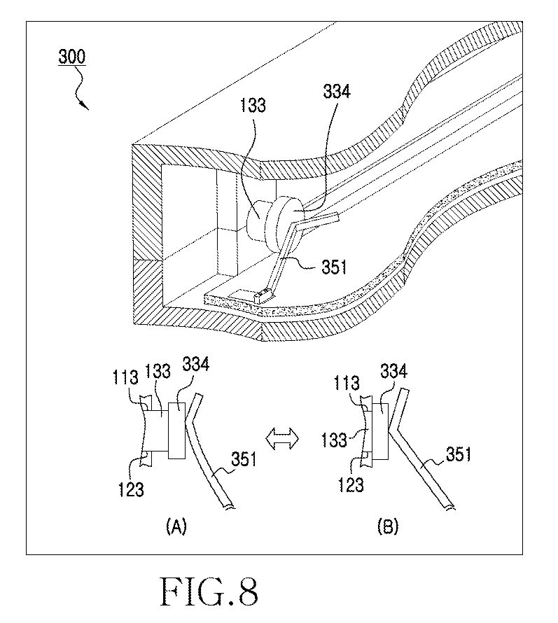

FIG. 8 is a view illustrating a sub antenna device according to an exemplary embodiment of the present invention. Description of the same elements as those of FIGS. 2 to 6 is omitted for clarity and convenience.

Referring to FIG. 8, and especially subframe (A) in FIG. 8, unlike the sub antenna device 100 and 200 described with reference to FIGS. 2 to 7, the sub antenna device 300 of FIG. 8 is configured to allow a plate spring 351 to apply pressure to the axial plane instead of the rotation plane of a second shaft 334 with elasticity so that the plate spring 351 electrically contacts the second shaft 334. Therefore, as illustrated in subframe (B) of FIG. 8, the plate spring 351 having a first end electrically connected to and supported by a feed part 141 (not shown) of a mainboard 140 (not shown) is elastically bent/transformed to apply pressure to the axial plane of the second shaft 334, and to electrically contact the axial plane when a slot cover including the second shaft 334 transfers.

In addition, besides the plate spring, a pogo pin for performing electrical contact by applying pressure to the rotation plane or the axial plane of the second shaft may be used as a medium for electrically connecting the slot cover with the feed part of the mainboard in FIGS. 2 to 8.

Moreover, a medium such as the plate spring, a pogo pin, a metal plate, etc. may be fixed to the top case frame, the bottom case frame, or the mainboard, and may be electrically connected with the feed part of the mainboard using a session cable.

Moreover, as described above, the entire portion of the slot cover may be formed of integral type metal in consideration of the transmission/reception of signals.

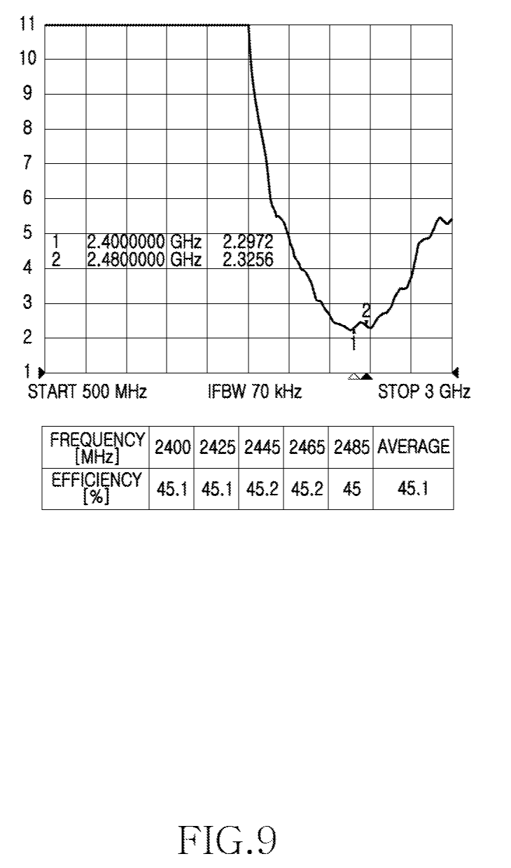

FIG. 9 is a view illustrating Voltage Standing Wave Ratio (VSWR) values and radiation efficiency in a Bluetooth frequency band when a sub antenna device according to an exemplary embodiment of the present invention is used.

Referring to FIG. 9, when a sub antenna device according to an exemplary embodiment of the present invention is used in the Bluetooth frequency band (2.4 GHz), radiation performance surpasses 45%.

Consequently, an antenna device of a portable wireless terminal according to an exemplary embodiment of the present invention may improve radiation performance by securing a space for an antenna radiator without increasing the volume of the terminal.

While the invention has been shown and described with reference to certain exemplary embodiments thereof, it will be understood by those skilled in the art that various changes in form and details may be made therein without departing from the spirit and scope of the invention as defined by the appended claims and their equivalents

What is claimed is:

1. An antenna device of a portable wireless terminal, the device comprising:
a mainboard comprising a feed part connected to a Radio Frequency (RF) connector;
a slot cover for opening/closing a slot formed in a case frame defining an outer surface of the portable wireless terminal in order to connect to a connector of an external apparatus, and comprising an antenna radiator for transmitting/receiving a signal; and
an electrical connection unit for electrically connecting the slot cover with the feed part.

2. The device of claim 1, wherein the slot cover further comprises:
a radiation portion comprising the antenna radiator;
a first metal shaft having a circular cross-section connected to the antenna radiator of the radiation portion; and
a second metal shaft connected to the first shaft and having a diameter greater than that of the first shaft.

3. The device of claim 2, wherein the antenna radiator comprises at least one of a flexible printed circuit having a radiation pattern, and a metal plate.

4. The device of claim 2, wherein the case frame comprises:
a seat formed to have a height difference from the slot, for seating the radiation portion; and
a rotation portion for receiving the first shaft in a fitting manner and allowing the radiation portion to transfer away from the case frame by a difference greater than the height difference and then to rotate at an outside of the case frame.

5. The device of claim 4, wherein the case frame further comprises a top case frame and a bottom case frame combined with the top case frame, and the combination of the top case frame and the bottom case frame provides the slot, the seat, and the rotation portion.

6. The device of claim 4, wherein the electrical connection unit comprises an elastic member having a first end connected to the feed part of the mainboard and having a second end supported by the first end and electrically connected to the second shaft by applying pressure to at least one of a rotation plane and an axial plane of the second shaft.

7. The device of claim 6, wherein the elastic member comprises at least one of a plate spring and a pogo pin.

8. The device of claim 6, wherein the electrical connection unit is at least one of screw-coupled and soldered to the feed part.

9. The device of claim 6, wherein the electrical connection unit is fixed to at least one of the case frame and the mainboard, and connected to the feed part of the mainboard using a session cable.

10. The device of claim 6, wherein the second shaft provides a sense of gradual rotation of the slot cover by forming a height difference of an interval in one of the rotation plane and the axial plane which the elastic member contacts.

11. The device of claim 1, wherein the slot cover comprises an integral type metal.

12. The device of claim 1, wherein the portable wireless terminal further comprises a second antenna device for transmitting/receiving a signal in the same frequency band as that of the antenna device, and compares signal strengths of the two antenna devices to use an antenna device that provides a stronger signal strength.

13. The device of claim 1, wherein the antenna device transmits/receives signals in at least one of a Bluetooth frequency band, a Wideband Code Division Multiple Access (WCDMA) frequency band, a Wireless Fidelity (Wi-Fi) frequency band, and a Satellite Digital Multimedia Broadcasting (SDMB) frequency band.

14. A portable wireless terminal comprising:
a mainboard comprising a feed part connected to a Radio Frequency (RF) connector;
a slot cover for opening/closing a slot formed in a case frame defining an outer surface of the portable wireless terminal in order to connect to a connector of an external apparatus, and comprising an antenna radiator for transmitting/receiving a signal; and
an electrical connection unit for electrically connecting the slot cover with the feed part.

15. The terminal of claim 14, wherein the slot cover further comprises:
a radiation portion comprising the antenna radiator;
a first metal shaft having a circular cross-section connected to the antenna radiator of the radiation portion; and
a second metal shaft connected to the first shaft and having a diameter greater than that of the first shaft.

16. The terminal of claim 15, wherein the antenna radiator comprises at least one of a flexible printed circuit having a radiation pattern, and a metal plate.

17. The terminal of claim 15, wherein the case frame comprises:
a seat formed to have a height difference from the slot, for seating the radiation portion; and
a rotation portion for receiving the first shaft in a fitting manner and allowing the radiation portion to transfer away from the case frame by a difference greater than the height difference and then to rotate at an outside of the case frame.

18. The terminal of claim 17, wherein the case frame further comprises a top case frame and a bottom case frame combined with the top case frame, and the combination of the top case frame and the bottom case frame provides the slot, the seat, and the rotation portion.

19. The terminal of claim 17, wherein the electrical connection unit comprises an elastic member having a first end connected to the feed part of the mainboard and having a second end supported by the first end and electrically connected to the second shaft by applying pressure to at least one of a rotation plane and an axial plane of the second shaft.

20. The terminal of claim 19, wherein the elastic member comprises at least one of a plate spring and a pogo pin.

21. The terminal of claim 19, wherein the electrical connection unit is at least one of screw-coupled and soldered to the feed part.

22. The terminal of claim 19, wherein the electrical connection unit is fixed to at least one of the case frame and the mainboard, and connected to the feed part of the mainboard using a session cable.

23. The terminal of claim 19, wherein the second shaft provides a sense of gradual rotation of the slot cover by forming a height difference of an interval in one of the rotation plane and the axial plane which the elastic member contacts.

24. The terminal of claim 14, wherein the slot cover comprises an integral type metal.

25. The terminal of claim 14, further comprising a second antenna device for transmitting/receiving a signal in the same frequency band as that of the antenna device, and the terminal compares signal strengths of the two antenna devices to use an antenna device that provides a stronger signal strength.

26. The terminal of claim 14, wherein the terminal transmits/receives signals in at least one of a Bluetooth frequency band, a Wideband Code Division Multiple Access (WCDMA) frequency band, a Wireless Fidelity (Wi-Fi) frequency band, and a Satellite Digital Multimedia Broadcasting (SDMB) frequency band.
